(19) United States
(12) Patent Application Publication
(10) Pub. No.: US 2006/0073353 A1
(43) Pub. Date: Apr. 6, 2006

(54) Profiles or tubes consisting of flexibly rolled strip material

(76) Inventor: Michael Rehse, Olpe (DE)

Correspondence Address: Wyatt, Gerber & O'Rourke, LLP, 99 Park Avenue, New York, NY, 10016, US

(21) Appl. No.: 11/240,346

(22) Filed: Sep. 30, 2005

(30) Foreign Application Priority Data
Oct. 1, 2004 (DE) 102004048406.6-24

(51) Int. Cl. B29C 53/00

(52) U.S. Cl. 428/586; 156/217; 29/897

(57) ABSTRACT

A profile or tube consisting of flexibly rolled strip material which comprises a variable material thickness in the rolling direction, wherein the profile or tube is provided with a longitudinal seam which extends in the rolling direction and which is positioned in the region of an overlap of the strip rims.

The invention relates to profiles or tubes consisting of flexibly rolled metal strip material which comprises a variable material thickness in the rolling direction. Furthermore, the invention relates to a process of producing such profiles or tubes.

Tubes or profiles consisting of flexibly rolled strip material whose wall thickness varies in the direction of the longitudinal axis can be adapted to special applications in such a way that those regions which are subject to greater loads comprise greater wall thicknesses and thus comprise higher strength values. It is also possible to use regions with a smaller wall thickness as especially weak zones which are intended for being used in motor vehicles as energy-absorbing crash elements.

After the cross-section has been closed, profiles and tubes of said type can also be adapted to deformation processes operating with internal pressure in such a way that regions undergoing a maximum material elongation are designed, initially, to comprise an increased wall thickness.

Until now, when tubes or profiles of this type were produced in such a way that starting from the flexibly rolled strip material a blank was cut which during a first deformation stage and was substantially bent into a profile dish which is open on one side and during a second stage closed in a die to form a closed profile. The upper die comprised a position holding strip which, on the finish-closed tube or profile, was intended to hold open a welding gap of a constant width.

In such a case, it is possible for squeezing to occur at the abutment faces of the welding gap. Furthermore, when closing the tube under pressure, using the position holding device, it is possible for bulges to form on the tube.

In order to reliably achieve a welding gap of a constant width, it has therefore so far been necessary to produce a straight cut along the irregularly formed side edges of a flexibly rolled strip material prior to forming a closed profile or tube.

### OBJECT OF THE INVENTION

It is therefore the object of the present invention to propose closed tubes or profiles of flexibly rolled material and a process of producing closed profiles and tubes of flexibly rolled material which ensure secure connections at the joints without the risk of damage or other disadvantages.

### SUMMARY OF THE INVENTION

The objective is achieved by providing a profile or tube of flexibly rolled metal strip material which comprises a variable material thickness in the rolling direction, wherein the profile or tube comprises a longitudinal seam which extends in the rolling direction and which is positioned in the region of an overlap of the strip rims. In a product of this invention, because of the advantageous inventive overlap, the irregular thickness or width of the flexibly rolled material in no way adversely affects the quality of the connection and thus of the closed profile as a whole. In a preferred embodiment, the strip rims are left in an uncut condition after the flexible rolling operation. This does not result in any disadvantages either when joining the strip rims in the region of the overlap. More particularly, the inventive product is suitable for continuous production purposes, using deformation rolling devices, as will be explained in greater detail at a later stage. The width of the inventive overlap for forming the seam connection has to be selected to be such that it is possible to produce a straight, axis-parallel longitudinal seam without any special difficulties in the region of overlap.

For producing the overlap, several shapes are possible which will be described later. All embodiments can be achieved on polygonal profiles as well as analogously on round or oval tubes.

### SUMMARY DESCRIPTION OF PREFERRED EMBODIMENT

According to a first preferred embodiment it is proposed that the longitudinal seam is provided in the region of an overlap which comprises a step formation at least of one strip rime which, more particularly, can be combined with planar design of the other strip rim. In this case, said step formation is the thickness of the material of the tube or profile, so that there is obtained an outwardly closed surface. More particularly, the step is offset inwardly, with reference to the cross-section of the profile or tube.

To the extent that planar surfaces are involved, these can, in the case of round or oval tubes, analogously and easily be bent around the longitudinal axis of the tube.

In the case of polygonal profiles, the overlap of said type can be positioned more particularly in the region of a side wall at a distance from the adjoining profile edges.

### SUMMARY DESCRIPTION OF A SECOND EMBODIMENT

According to a second embodiment, it is proposed that the longitudinal seam be formed in the region of an overlap which consists of a single obtuse-angled bend of a strip rim and of a part of a double obtuse-angled bend the other strip rim with changing angles, which part is nearest to the rim. In this way, it is possible to produce a flat V-groove which is slightly set back relative to a planar surface of a polygonal profile or relative to a uniformly bent surface of a round or oval tube. In the preferred embodiment explained later it is proposed that the single obtuse-angled bend be positioned inside with reference to the closed profile or tube. In this case, it is also proposed that the overlap is positioned in the region of a side wall at a distance from two adjoining profile edges because the selected geometry is less suitable for an edge position.

### SUMMARY DESCRIPTION OF A THIRD EMBODIMENT

According to a third embodiment it is proposed that the longitudinal seam be formed in the region of an overlap which comprises a bend of the one strip rim, which can be combined with a planar design of the second strip rim. More particularly, the closed profile can be a polygonal profile, and the overlap can be provided in a region adjoining a longitudinal edge of the profile. A side wall is extended in a straight line beyond the closed profile cross-section, and the side wall abutting thereon is bent at a right angle outwardly or inwardly, so that the inventive overlap is produced.

Finally, according to a further embodiment it is proposed that the longitudinal seam be formed in the region of an overlap which consists of substantially symmetric bends of both strip rims which, with reference to the profile cross-section, both point outwardly.

### SUMMARY DESCRIPTION OF A PREFERRED FURTHER EMBODIMENT

For all said embodiments, a preferred further embodiment consists in that, in the region of the closed profile, the changes in the material thickness in the longitudinal direction take place on the inside only. This presupposes a change in thickness on one side only of the flexibly rolled starting material. In the case of the preferred embodiment there is thus produced a tube or profile which is smooth on the outside and comprises a uniform cross-section and in which the changes in wall thickness, at most, are visible in the region of the seam connection. This connection, in a preferred embodiment refers to a welded connection and more particularly to a laser-welded connection because of the small amount of heat distortion involved. Resistance welding process, fusion welding processes or electron beam welding processes can be used as well. In principle, it is also possible to use glued connection, soldered connections, clinched, riveted or other equivalent connections

Furthermore, the above-mentioned objective is achieved by a process of producing profiles or tubes of flexibly rolled metal strip material comprise a variable material thickness in the rolling direction wherein the profile or tube is produced so as to comprise a longitudinal seam which extends in the rolling direction of the metal strip material and which is positioned in the region of an overlap of the strip rims. In a preferred embodiment, there is thus produced a non-releasable connection between the strip rims in the region of the overlap, which strip rims remain uncut after the flexible rolling operation. As already indicated, the main advantage consists in that the production of tubes or profiles from flexibly rolled material can now be carried out continuously without there existing any quality risks, more particularly also by eliminating the operation of cutting irregularly spaced side edges in that the strip ruins into a profile rolling device and can be connected continuously, with cutting to length taking place only on the finished tube or profile member. On the other hand, the use of a discontinuous process wherein, first, blanks are cut to length and then formed into profiles is not excluded. In this case, too, the main advantage consists in that the different material thicknesses along the length and possibly the irregularly extending side edges do not represent a quality problem when closing the profile, but remain insignificant due to the inventive overlap.

According to a preferred type of process, it is proposed that after the flexibly rolling operation, wedged or round grooves are rolled into the strip material along subsequently produced profile edges. In the region of the groove base, a constant residual thickness of the strip material is aimed at in order to achieve uniform bending radii. In this way, the sharp-edged formation of polygonal profiles is facilitated.

As already mentioned, the preferred type of connection consists in through-welding in the region of the overlap, more particularly by laser welding. However, the process is not limited to this connection technology.

Furthermore, it is proposed that profile rolling takes place in such a way that the forming rolls act on a planar side of the flexibly rolled stirrup material, so that there occurs a smooth outer surface with a constant cross-section. For securely closing the overlap, the welding device used can be associated with a pressure roller (embodiments 1 and 2) or pairs of pressure rollers (embodiments 3 and 4). After the tube or profile has been welded to form a closed member, use is preferably made of a heat treatment for stress relieving purposes. Deformation stages in accordance with the internal high pressure deformation process can follow.

### BRIEF DESCRIPTION OF THE DRAWINGS

The drawings show basic problems occurring when producing profiles from flexibly rolled strip material as well as preferred embodiments of profiles produced in accordance with the invention.

FIG. 1 illustrates a square profile closed by a butt joint and consisting of a flexibly rolled strip material
a) in the form of the starting material
b) as a finish-closed profile
c) an enlarged detail in a plan view of the region of the butt joint.

FIG. 2 illustrates a square profile closed by a T-joint and consisting of a flexibly rolled strip material
a) in the form of the starting material
b) as a finish-closed profile
c) an enlarged side view detail in the region of the T-joint.

FIG. 3 illustrates a square profile closed in accordance with the invention in the region of an overlap and consisting of a flexibly rolled strip material in a first embodiment
a) in the form of the starting material
b) as a finish-closed profile
c) an enlarged detail illustration in the region of the overlap.

FIG. 4 illustrates a square profile closed in accordance with the invention in the region of an overlap and consisting of a flexibly rolled strip material in a second embodiment
a) in the form of the starting material
b) as a finish-closed profile
c) an enlarged detail illustration in the region of the overlap.

FIG. 5 illustrates a square profile closed in accordance with the invention in the region of an overlap in a third embodiment
a) in the form of the starting material
b) as a finish-closed profile
c) an enlarged detail illustration in the region of an L-seam.
d) an enlarged side view illustration in the region of the L-seam.

FIG. 6 illustrates a square profile closed in accordance with the invention in the region of an overlap in a fourth embodiment
a) in the form of the starting material
b) as a finish-closed profile
c) an enlarged detail illustration in the region of an L-seam.
d) an enlarged side view illustration in the region of the L-seam.

FIG. 7 illustrates a portion of a flexibly rolled strip material with a rolled-in round seam or groove.

FIG. 8 illustrates a square profile closed in accordance with the invention in the region of an overlap in a fifth embodiment.

Illustration a of FIG. 1 shows a portion of flexibly rolled strip material with the rolling direction being indicated by an arrow P. The portion can be regarded as a portion of a continuos strip or as a blank cut to length from the continuous strip, which is of no significance for the problems illustrated here. Three longitudinal regions 11, 12, 13 of different material or wall thicknesses following one another in the rolling direction P are shown at the strip portion, with the unhatched portion 11 having the smallest wall thickness, the portion 12 hatched in a first way having an increasing wall thickness and with the differently hatched portion 13 having a constant greater wall thickness. It is possible to identify side edges or strip rims 14, 15 which extend substantially parallel to the rolling direction P and which, starting from the originally available strip material of a constant material thickness, after the flexible rolling operation, with an increasing material thickness, comprise a greater transverse distance from one another. Between the side edges 14, 15 it is possible to see four longitudinal markings 16, 17, 18, 19 which can be regarded as virtual markings of the subsequently obtained profile edges or which, after the flexible rolling operation, can constitute rolled-in longitudinal grooves or furrows in order to facilitate the subsequent profile rolling or bending to form a profile. Such furrows formed with fixed profile rims extend strictly parallel to the rolling direction P.

Illustration b of FIG. 1 shows a square profile 21 which is produced from the material according to illustration a) and which shows a butt joint 24 centrally on an upper side face. The square profile 21 can be produced by a profile rolling process using roller sets following one another with continuously changing cross-sections. However, it can also be produced by a simple bending process along markings 16, 17, 18, 19.

The problems involved with a profile produced in such a way from flexibly rolled strip material are obvious from illustration c in which it is possible, again, to see the portions 11, 12, and 13 with increasing material thicknesses. The more intensely rolled portion 11 has a reduced strip width relative to the less intensely rolled portion 13, which is obvious from the type of width of the butt joint 24 which, first, has a greater width in the region 11, then a decreasing width in the region 12 and finally a smallest constant width in the region 13. As a result of the more intense rolling in the region 11 relative to the region 13, the higher tensile forces during the rolling process have a tendency leading to necking in the strip width.

The resulting butt seam 24 with a variable width cannot be closed by laser welding because it requires a constantly observed butt seam width. This means that the profile shown here is totally unsuitable for a continuous process which directly follows a profile rolling operation.

Illustration a of FIG. 2 again shows a portion of flexibly rolled strip material similar to that of FIG. 1, with the reference numbers of corresponding details having been increased by 20. To that extent, reference is made to the description of FIG. 1. Again, there is shown an arrow P which indicates the rolling direction of the strip material. In the longitudinal direction, there are again provided three portions of different material thicknesses, with the portion 31 having the smallest wall thickness, the portion 32 an increasing wall thickness and the portion 33 being rolled to the least extent and thus having the greatest wall thickness.

Accordingly, the transverse distance between the side edges 34, 35 increases in the rolling direction. In this case, between the side edges 34, 35 there are shown only three longitudinal markings 36, 37, 38 which are parallel relative to one another and assume the same significance as the corresponding markings in illustration a of FIG. 1. The longitudinal markings thus indicate the position of subsequently produced bending lines which can be, but do not have to be, simultaneously rolled-in furrows or grooves in the material.

Illustration b of FIG. 2 shows a square profile 41 with a square cross-section wherein a lower side face 43 comprises a greater width than the three remaining side faces, so that a right-hand side face 44 abuts the side face 43, thus forming a T-seam 44.

Illustration c of FIG. 2 again shows the portions 31, 32, 33 with a decreasing width and an increasing material thickness. In a side view, more particularly at the side face 43, there is shown the initially smaller wall thickness of the portion 31, the then increasing wall thickness of the portion 32 and finally the greatest wall thickness of the portion 33. As a result of the increasingly reduced rolling rate and thus the increasing strip width, the butt seam 44 is initially larger, then decreases in size and is closed in the region of the portion 33. A seam of this kind cannot be reliably closed by laser welding. A profile of the type shown here is thus unsuitable for a continuous profile producing process.

It is not claimed that the processes and products shown in FIGS. 1 and 2 form part of the state of the art. However, they do not correspond to the subject of the present invention of which five embodiments will be described below.

Illustration a of FIG. 3 again shows a portion of the flexibly rolled strip material of which, in the longitudinal direction, there is shown a first portion 51 with the smallest wall thickness, a second portion 52 with a decreasing wall thickness and a third portion 53 whose wall thickness is greater than that of portion 51. An arrow P marks the rolling direction of the flexibly rolled material. Because of the decreasing rolling rate in the rolling direction P, the transverse distance between the side edges 54, 55 increases. Markings 56, 57, 58, 59 are shown so as to extend parallel relative to one another and in the rolling direction and indicate the position of the subsequently produced edges of the square profile to be formed. These can be regarded as virtual edges or can be prepared by furrows or grooves which are formed after the flexible rolling operation. In addition, there is shown a double marking 60 for a flat step, which double marking 60 also extends parallel to the markings 56, 57, 58, 59 or to the side edge 54. The distance between the marking 56 and the side edge 54 is increased by the step 60 relative to the distance between the marking 59 and the side edge 55. There is thus obtained an overlap which will be described below.

Illustration b of FIG. 3 shows a square profile 61 which is produced from the strip portion according to illustration a and which comprises an overlap 62 on the upper side. The type of overlap is more easily recognizable in illustration c of FIG. 3 in which there are first marked the longitudinal portions 51 with a smaller material thickness, 52 with an increasing material thickness and 53 whose material thickness is increased relative to 51. As far as details are concerned, it is possible to identify the flat step 60 which, on the finished profile, extends towards the inside of the profile.

The step 60, together with the material portion ending in a planar condition, forms the overlap 62 which, together with the step forms a residual gap 63. As a result of the highest rolling rate in the region of the portion 51, the residual gap 63 is widest here, whereas with a rolling rate decreasing in the rolling direction and thus an increasing material thickness, the residual gap 63 is smaller and is finally closed. However, the gap width of the residual gap 63 is insignificant because a weld 64 is produced by the weld focus 65 in the region of the overlap 62. To that extent, the profile with the variable strip width and the variable distance between the strip rims is continuously reliably closed by the weld 64.

Illustration a of FIG. 4 again shows a portion of a flexibly rolled strip on which the rolling direction is marked by the arrow P. In the longitudinal direction of the strip there is shown a strip portion 71 of a smallest wall thickness, a second strip portion 72 with an increasing wall thickness as well as a third strip portion 73 with a greatest wall thickness, as shown in the preceding figures. As a result of the decreasing rolling rate, the distance between the strip rims 74, 75 or side edges in the rolling direction increases. The illustration shows markings 76, 77, 78, 79 which extend parallel to the rolling direction and parallel relative to one another and which can be regarded, virtually, as the position of the subsequently produced edges of the hollow profile or are able to actually form these edges by already existing furrows or grooves. A single, obtuse-angled bend 80₁ at the side edge 74 and a double obtuse-angled bend 80₂ with changing angles at the side edge 75 extend parallel to the markings 76, 77, 78, 79 or parallel to the side edges 74, 75.

Illustration b of FIG. 4 shows the complete square profile which, on its upper side, comprises a countersunk overlap 82 whose details are more clearly visible in illustration c. Illustration c of FIG. 4 shows the regions 71, 72, 73 whose material thicknesses increase in the rolling direction and whose rolling rate therefore decreases. The type of overlap 82 is more clearly identifiable and consists of a singe obtuse-angled bend 80₁ and a double obtuse-angled bend 80₂, with the second bend being produced in a different direction and the free leg of the double bend being positioned in a planar way and parallel to the first bend 80₁. As can be seen in the illustration, the rolling rate decreasing in the rolling direction is accompanied by an increase in the transverse distance between the side edges and thus by an increase in the degree of cover in the region of the overlap 82. The width of the gap 83 thus decreases in the rolling direction. However, this is insignificant because, in the region of the secure overlap, there is produced a straight-line longitudinal seam 84 by a welding focus 85 so that, irrespective of the variable width of the strip material with uncut strip rims 74, 75, a secure overlap thereto and outwardly, there is formed the inventive overlap 102 which, in the direction of the decreasing rolling rate and the rolling direction, becomes increasingly wider. The security of the connection is thus not achieved because a straight weld 104 which is produced by a welding focus 105 securely closes the profile independently of the width of the overlap.

Illustration a of FIG. 6, again shows a portion of a flexibly rolled strip material whose material thickness increases in the rolling direction P. A first portion 111 is thus subjected to the highest rolling rate, a second portion 112 comprises an increasing material thickness and a third portion 113 is subjected to the lowest rolling rate and thus comprises the greatest material thickness. Thus, the transverse distance between the side edges 114, 115 increases in the rolling direction. There are shown three markings 116, 117, 118 which extend in the longitudinal direction and parallel relative to one another and which separate four outer sides of a finished square profile. The distance between the marking 118 and the side edge 115 is considerably greater than the distance between the marking 116 and the side edge 114. There is provided a further marking 120 which extends parallel to the markings 116, 117, 118 or parallel to the side edge 114 and which indicates the position of a subsequently produced rectangular inwardly extending bend. The markings 116, 117, 118, 120 can be interpreted as being of a purely virtual nature or they can indicate the position of furrows or grooves which facilitate subsequent bending operation.

Illustration b of FIG. 6 shows a finished square profile 121 wherein a lower side wall 123 clearly projects from the right-hand side wall 127. At the side wall 127, there is provided a bend 126 which is arranged so as to extend parallel to the projecting side wall 123. In illustrations c and d of FIG. 6, there are again marked exists along the entire length, with the profile being securely closed. There is no need for any clamping or the like, so that the product is superbly suited for a continuous process.

Illustration a of FIG. 5 again shows a portion of flexibly rolled strip material whose material thickness increases in the rolling direction P. A first portion 91 is thus subjected to the highest rolling rate, a second portion 92 comprises an increasing material thickness and a third portion 93 is subjected to the lowest rolling rate and comprises the greatest material thickness. The transverse distance between the side edges 94, 95 thus increases in the rolling direction. There are shown three markings 96, 97, 98 which extend in the longitudinal direction and parallel relative to one another and which separate four outer sides of a finished square profile. The distance between the marking 98 and the side edge 95 is considerably greater than the distance between the marking 96 and the side edge 94. There is provided a further marking 100 which extends parallel to the markings 96, 97, 98 or parallel to the side edge 94 and which indicates the position of a subsequently produced rectangular outwardly extending bend. The markings 96, 97, 98, 100 can be interpreted as being of a purely virtual nature or as indicating the position of furrows or grooves which facilitate subsequent bending operation.

Illustration b of FIG. 5 shows a finished square profile 101 wherein a lower side wall 103 clearly projects beyond the right-hand side wall 107. The side wall 107 is provided with a bend 106 which is positioned so as to extend parallel to the projecting side wall 103. In illustrations c and d of FIG. 5, the longitudinal portions 91, 92, 93 whose wall thicknesses increases in the rolling direction are again marked. As a result of the bend 106 at the right-hand side wall 107, which bend 106 is positioned on the projecting lower wall 103 so as to extend parallel the longitudinal portions 111, 112, 113 whose wall thicknesses increase in the rolling direction. As a result of the bend 126 at the right-hand side wall 127 which is positioned on the projecting lower wall 123 so as to extend parallel thereto and inwardly, there is formed the inventive overlap 122 which becomes increasingly wider in the direction of the decreasing rolling rate in the rolling direction. The security of the connection is thus not achieved because a straight weld 124 which is produced by a welding focus 125, securely closes the profile independently of the width of the overlap.

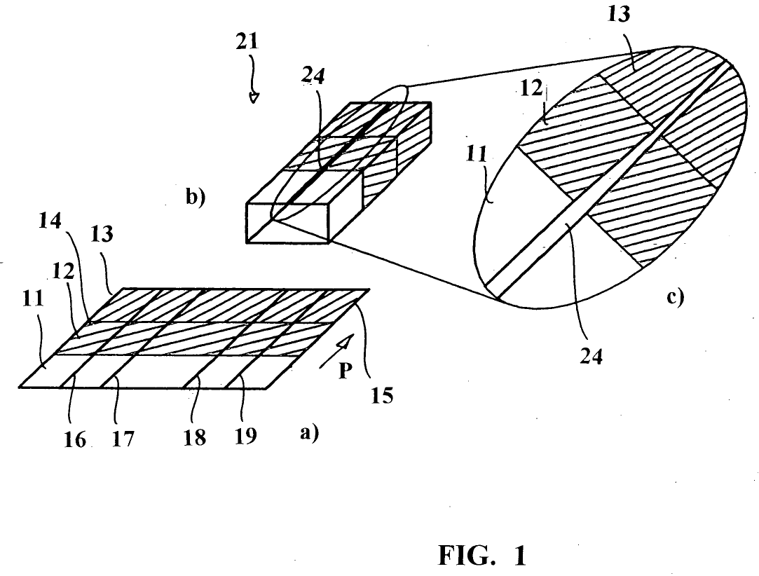

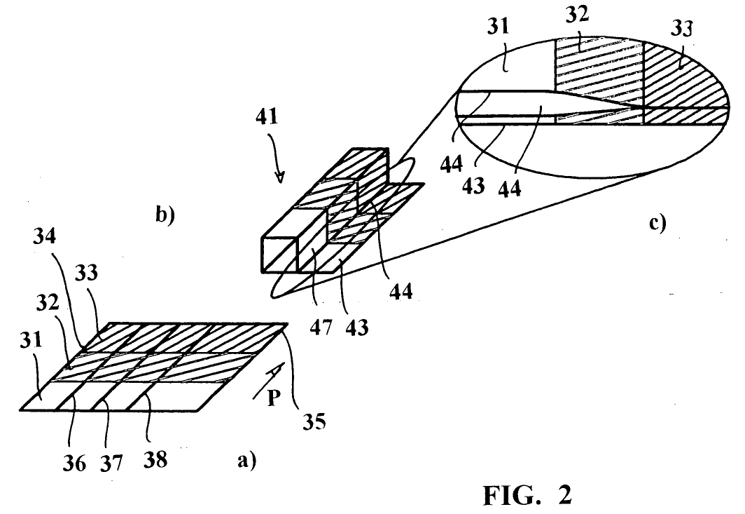

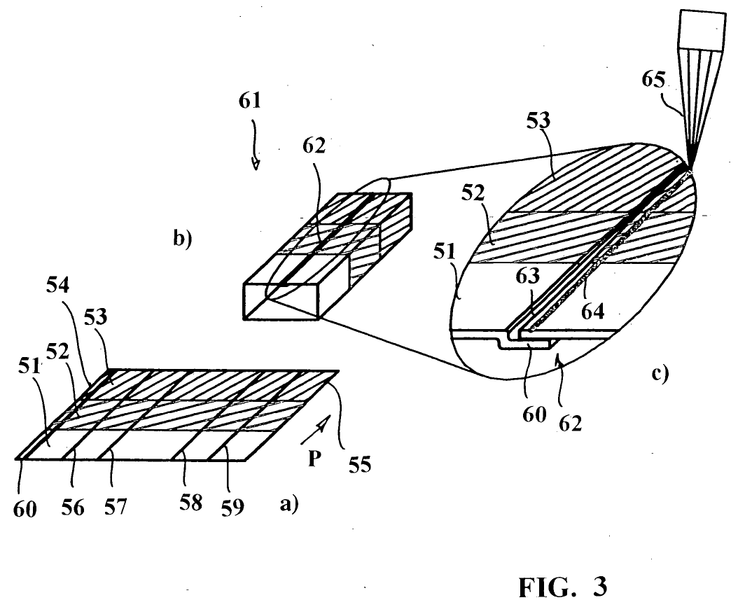

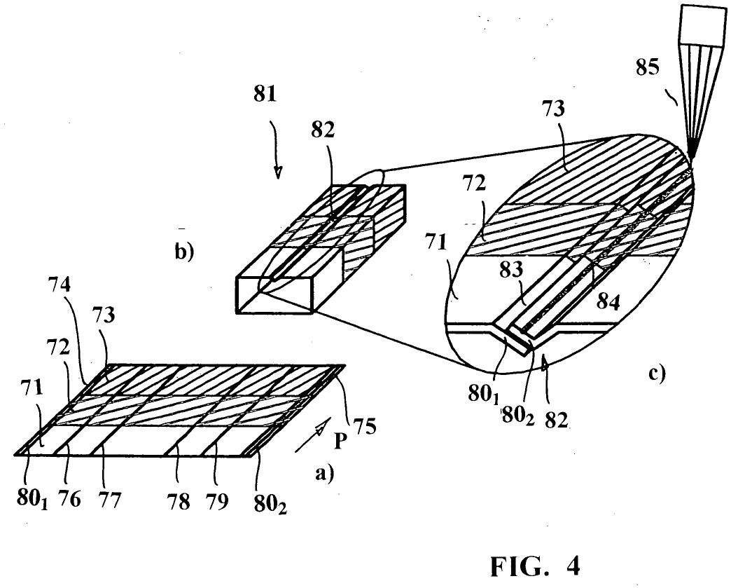

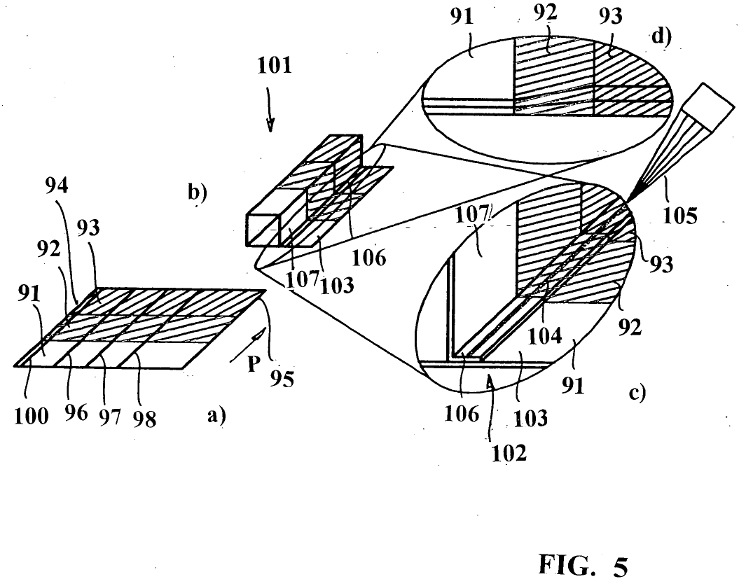

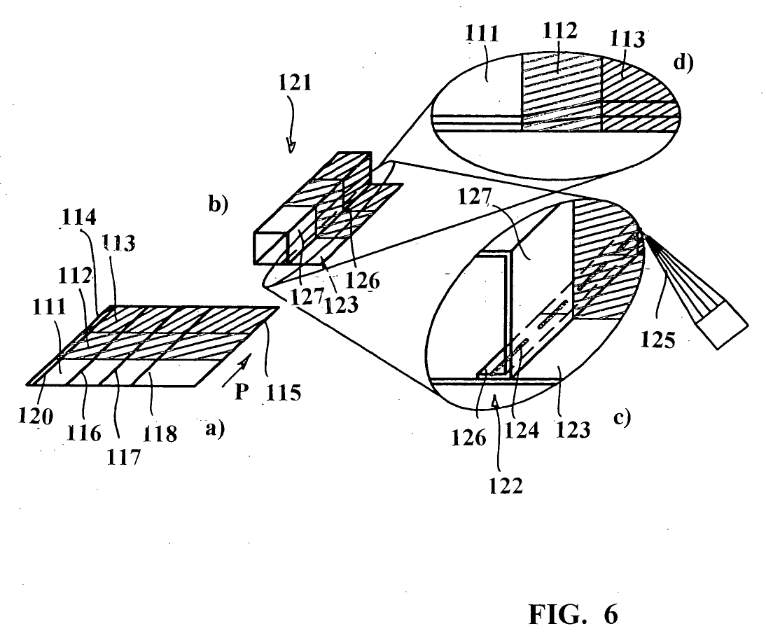

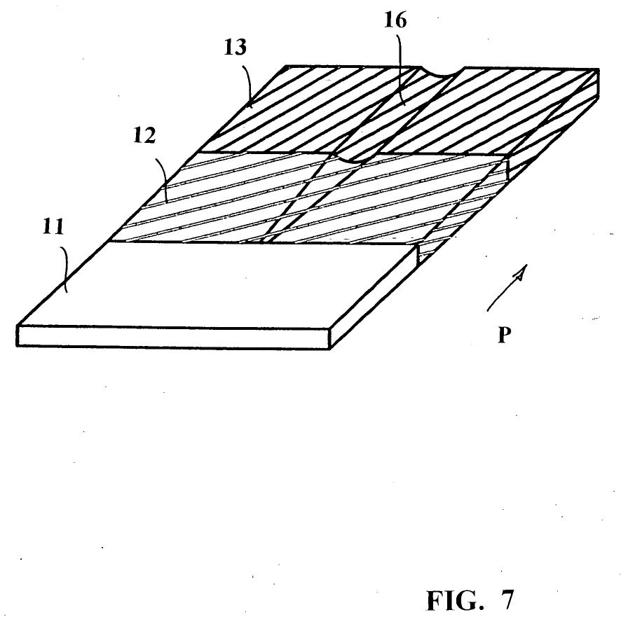

FIG. 7 shows a portion of the strip material according to FIG. 1 for example which, if viewed in the rolling direction P, is shown to comprise three portions with an initially small wall thickness 111, then an increasing wall thickness 12 and finally a greater wall thickness 13. The surface is shown to comprise a round groove or furrow 16 which extends over the portions 12, 13 and whose base line comprises a constant distance from the planar underside of the strip portion. It can be assumed that the longitudinal groove is provided by a fixed rolling tool. In consequence, the width and depth as formed, if viewed from the upper side, are the greater the greater the material thickness.

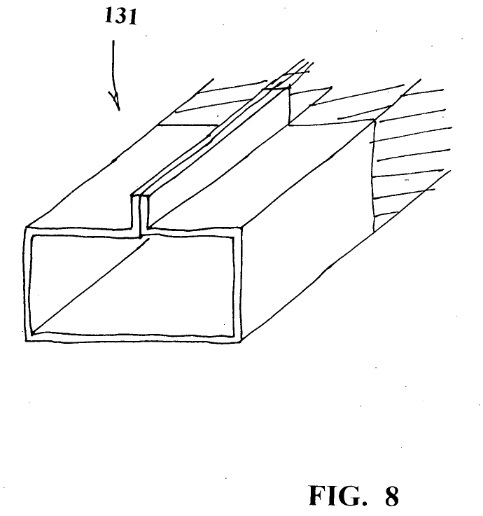

FIG. 8 shows a finished square profile 131 on which a longitudinal seam is formed in the region of an overlap which consists of substantially symmetric bends on both strip rims which, with reference to the profile cross-section, both point outwardly.

1. A profile or tube consisting of flexibly rolled strip material which comprises a variable material thickness in the rolling direction, wherein the profile or tube is provided with a longitudinal seam which extends in the rolling direction and which is positioned in the region of an overlap of the strip edge rims.

2. A profile or tube according to claim 1, wherein said strip edge rims forming said overlap are uncut after the flexible rolling operation.

3. A profile or tube according to claims 1 or 2, wherein said longitudinal seam is provided in the region of said overlap which comprises a step formation on one strip edge.

4. A profile or tube according to claims 1 or 2, wherein said longitudinal seam is provided in the region of said overlap which comprises a step formation on one strip edge and having a step formation for a closed profile or tube which is formed towards the inside and with the other strip edge overlaping the same on the outside.

5. A profile or tube according to claims 1 or 2, wherein said longitudinal seam is provided in the region of said overlap which comprises a step formation on one strip edge and having a step formation for a closed profile or tube which is formed towards the inside and with the other strip edge overlaping the same on the outside, and whith said closed profile or tube constituting a polygonal profile and that said overlap is positioned in the region of a side wall at a distance from two profile edges.

6. A profile or tube according to claims 1 or 2, wherein said longitudinal seam is formed in the region of said overlap which consists of a single obtuse-angled bend of a strip rim and of a part of a double obtuse-angled bend of the other strip rim with changing angles which part is nearest to the rim.

7. A tube or profile according to claims 1 or 2, wherein said longitudinal seam is formed in the region of said overlap which consists of a single obtuse-angled bend of a strip rim and of a part of a double obtuse-angled bend of the other strip rim with changing angles which part is nearest to the rim, and wherein said single obtuse-angled bend with reference to the closed tube or profile is positioned on the inside.

8. A profile according to claims 1 or 2, wherein said longitudinal seam is formed in the region of said overlap which consists of a single obtuse-angled bend of a strip rim and of a part of a double obtuse-angled bend of the other strip rim with changing angles which part is nearest to the rim, and wherein said single obtuse-angled bend with reference to the closed tube or profile is positioned on the inside and wherein said closed profile is a polygonal profile and said overlap is positioned in the region of a side wall at a distance from two profile edges.

9. A tube or profile according to any one of claims 1 or 2, wherein said longitudinal seam is provided in the region of said overlap comprised of a bend of a strip rim.

10. A profile according to claims 1 or 2, wherein said longitudinal seam is provided in the region of said overlap comprised of a bend of a strip rim and whererin the closed profile is formed as a polygonal profile and said the overlap, is formed so as to adjoin a longitudinal edge of said profile.

11. A profile or tube according to claims 1 or 2, wherein said longitudinal seam is provided in the region of said overlap comprised of a bend of a strip rim and whererin the closed profile is formed as a polygonal profile and said the overlap, is formed so as to adjoin a longitudinal edge of said profile, and wherein said bend forms a closed profile extending outwardly.

12. A profile or tube according to claims 1 or 2, wherein a profile according to claims 1 or 2, wherein said longitudinal seam is provided in the region of said overlap comprised of a bend of a strip rim and wherein the closed profile is formed as a polygonal profile and that said overlap is formed so as to adjoin a longitudinal edge of said profile and wherein said bend with reference to said closed profile extends inwardly.

13. A profile or tube according to claims 1 or 2, wherein in the region of a closed profile, the changes in material thickness in the longitudinal direction occur only on the inside of the profile.

14. A process of producing profiles or tubes from flexibly rolled strip material which comprises a variable material thickness in the rolling direction and wherein the profile or tube is produced with a longitudinal seam which extends in the rolling direction of said strip material and which is positioned in the region of an overlap of the strip edge rims.

15. A process according to claim 14, whererin there is produced a non-releasable connection between said strip rims in the region of said overlap, with said strip rims being uncut after the flexible rolling operation.

16. A process according to claims 14 or 15, wherein said flexibly rolled strip material is continuously closed by a profile rolling process and that thereafter individual profile blanks are cut to length.

17. A process according to claims 14 or 15, and wherein said flexibly rolled strip material is continuously closed by a profile rolling process and that thereafter individual profile blanks are cut to length and wherein said individual blanks are cut to length from the flexibly rolled strip material and that thereafter individual blank profiles are bent so as to form edges so as to be round and then closed.

18. A process according to claims 14 or 15, wherein said flexibly rolled strip material is continuously closed by a profile rolling process and that thereafter individual profile blanks are cut to length and wherein said individual blanks are cut to length from the flexibly rolled strip material and that thereafter individual blank profiles are bent so as to form edges so as to be round and then closed, and wherein after said flexible rolling operation wedge-formed or round grooves are rolled into said strip material along subsequently produced profile edges to a constant residual thickness of said strip material.

19. A process according to claims 14 or 15, wherein said flexibly rolled strip material is continuously closed by a profile rolling process and that thereafter individual profile blanks are cut to length and wherein said individual blanks are cut to length from the flexibly rolled strip material and that thereafter individual blank profiles are bent so as to form edges so as to be round and then closed, and wherein after said flexible rolling operation wedge-formed or round grooves are rolled into said strip material along subsequently produced profile edges to a constant residual thickness of said strip material, wherein said longitudinal seam in the region of the overlap is welded through by laser welding.

20. A process according to claims 14 or 15, wherein on one side, said flexible strip material is rolled so as to comprise a substantially planar surface which is positioned on the outside of the finished tube or profile.

21. A process according to claims 14 or 15, wherein when producing said longitudinal seam at least one pressure roller is applied a welding device for the purpose of closing the overlap.

22. A process according to claims 14 or 15, wherein when producing said longitudinal seam at least one pressure roller is applied a welding device for the purpose of closing the overlap and then after the profile or tube has been welded, a heat treatment takes place for stress relieving purposes or for improving the material properties.
